(19) United States
(12) Patent Application Publication
(10) Pub. No.: US 2019/0168467 A1
(43) Pub. Date: Jun. 6, 2019

(54) PRESS FORMING METHOD AND PRESS FORMING APPARATUS FOR CONTINUOUS FIBER COMPOSITE SHEET

(71) Applicant: Swancor Ind. Co., Ltd., Nantou County (TW)

(72) Inventors: Yu-Tsan Tseng, Nantou County (TW); Wen-Pang Chiang, Nantou County (TW)

(73) Assignee: Swancor Ind. Co., Ltd., Nantou County (TW)

(21) Appl. No.: 15/896,087

(22) Filed: Feb. 14, 2018

(30) Foreign Application Priority Data
Dec. 1, 2017 (TW) 106142272

(51) Int. Cl. B29C 70/46; B29C 51/26; B29C 51/08; B29C 51/10; B29C 51/20; B29C 51/42

(52) U.S. Cl. CPC B29C 70/46; B29C 51/262; B29C 51/082; B29K 2101/12; B29C 51/20; B29C 51/421; B29C 2791/006; B29C 51/105

(57) ABSTRACT

A press forming method for continuous fiber composite sheets including the following steps is provided. Firstly, a plurality of continuous fiber composite sheets are provided. Then, the continuous fiber composite sheets are heated. Then, a mold having a plurality of cavities is provided. After that, the continuous fiber composite sheets are respectively placed into the cavities, and the continuous fiber composite sheets are molded respectively. A press forming apparatus for continuous fiber composite sheet is also provided.

### CROSS-REFERENCE TO RELATED APPLICATION

This application claims the priority benefit of Taiwan application serial no. 106142272, filed on Dec. 1, 2017. The entirety of the above-mentioned patent application is hereby incorporated by reference herein and made a part of this specification.

### BACKGROUND OF THE INVENTION

### Field of the Invention

The invention is related to a press forming method and a press forming apparatus, and particular to a press forming method and a press forming apparatus for continuous fiber composite sheet.

### Description of Related Art

In existing manufacturing methods for thermo-plastic carbon fiber products, due to poor ductility of thermo-plastic carbon fiber sheet, most of the molds used for manufacturing thermo-plastic carbon fiber products only have one cavity. Only one piece of thermo-plastic carbon fiber product can be obtained from each molding process, resulting in poor manufacturing efficiency. If a plurality of thermo-plastic carbon fiber products are to be manufactured at the same time, a plurality of molds are required, which leads to high manufacturing cost.

Although the design of multi-cavity mold has been proposed, it is mostly suitable for metal stamping, blank stamping or plastic injection molding. Unlike metal and blank which have better ductility, and plastic injection molding which injects molten plastic material into the cavity, the thermo-plastic carbon fiber sheet with lower ductility is likely to cause the yarn to be pulled, crooked or broken during the molding process. Accordingly, the mold used for metal stamping, blank stamping and plastic injection molding is not suitable for manufacturing thermo-plastic carbon fiber product.

Taiwan Patent Publication No. TW 201103736 discloses a multi-cavity mold, and a male die thereof includes a first plate, a second plate, a plurality of male cores and a plurality of restricting plates. The first plate has a plurality of male cavities, and the second plate has a plurality of accommodating grooves disposed as corresponding to the cavities. On the other hand, the male cores are respectively disposed in the male cavities, and the restricting plates are respectively disposed in the accommodating grooves, and each male core are restricted to their positions through the corresponding restricting plates. Therefore, when the male core or the male cavity is under repair, the relative position of each male core on the first plate is not changed due to dissembling or assembling of mold, which facilitates to save the time for correcting the male core.

Chinese Patent Publication No. CN 101528616 A discloses a molded article, of which a plurality of lower molds are disposed in a lower mold retainer with a degree of freedom of moving horizontally relative to the lower mold retainer. A plurality of cylindrical molds are fixed on an upper mold retainer, and a plurality of upper molds are respectively fixed in the cylindrical molds. In this manner, in the process that each upper mold is combined with a corresponding lower mold, the coaxiality of each upper mold and the corresponding lower mold can be ensured so that each upper mold and the corresponding lower mold can be aligned with the blank located between the upper mold and the lower mold to be accurately pressed and formed.

US Patent Publication No. US 20100151069 A1 discloses a multi-cavity mold for manufacturing plastic bottles, which can simultaneously manufacture a plurality of plastic bottles in multiple cavities of the same mold through an injection molding method.

The above-mentioned patents are not applied in manufacturing thermo-plastic carbon fiber products, and do not take into consideration of the conditions of pulled yarn, crooked yarn or broken yarn that are likely to be generated when the thermo-plastic carbon fiber sheets are pressed and formed, and thus are not suitable for manufacturing thermo-plastic carbon fiber products.

### SUMMARY OF THE INVENTION

The invention provides a press forming method and a press forming apparatus for a continuous fiber composite sheet, which facilitates to improve manufacturing efficiency and quality of products.

In the invention, the press forming method for the continuous fiber composite sheet includes the following steps. First of all, a plurality of continuous fiber composite sheets are provided. Next, the continuous fiber composite sheets are heated. Thereafter, a mold having a plurality of cavities is provided. After that, the continuous fiber composite sheets are respectively placed into the cavities so that the continuous fiber composite sheets are molded respectively.

In an embodiment of the invention, the press forming method for the continuous fiber composite sheets further include a step of adjusting tension of the continuous fiber composite sheets respectively prior to heating the continuous fiber composite sheets.

In an embodiment of the invention, the press forming method for the continuous fiber composite sheets further includes a step of adjusting tension of the continuous fiber composite sheets respectively in the process that the continuous fiber composite sheets are heated.

In an embodiment of the invention, the press forming method for the continuous fiber composite sheets further includes a step of adjusting tension of the continuous fiber composite sheets respectively in the process that the continuous fiber composite sheets are molded respectively.

In an embodiment of the invention, the method of pressing and forming the continuous fiber composite sheets respectively includes molded forming, pressure forming or vacuum forming method.

In an embodiment of the invention, the mold includes a male mold and a female mold. The male mold has a plurality of protrusions, and the female mold has a plurality of recesses. When the continuous fiber composite sheets are respectively placed into the cavities, each of the continuous fiber composite sheets is disposed right above the corresponding recess, and the male mold and the female mold are combined after each protrusion and the corresponding recess are aligned with each other so that each of the continuous fiber composite sheets is pressed into a cavity constructed by the combined protrusion and recess corresponding to each other.

In an embodiment of the invention, the continuous fiber composite sheets are clamped onto a carrier. The carrier has a plurality of through holes, and one continuous fiber composite sheet is clamped right above each of the through holes. When the continuous fiber composite sheets are respectively placed into the cavities, the carrier is moved to be located between the male mold and the female mold, and the male mold and the female mold are combined after each of the through holes is aligned with the corresponding protrusion and recess so that each of the protrusions passes through the corresponding through hole to press the corresponding continuous fiber composite sheet into the corresponding recess.

In the invention, a press forming apparatus for a continuous fiber composite sheet includes a plurality of clamping devices, a heater and a mold. The clamping devices are respectively configured to clamp a plurality of continuous fiber composite sheets. The heater is configured to heat the continuous fiber composite sheets. The mold is disposed at one side of the heater and has a plurality of cavities. After the heater heats the continuous fiber composite sheets, the clamping devices are utilized to move the continuous fiber composite sheets to the position where the mold is located. Then, the continuous fiber composite sheets are respectively placed into the cavities so that the continuous fiber composite sheets are molded respectively.

In an embodiment of the invention, the mold includes a male mold and a female mold. The male mold has a plurality of protrusions, and the female mold has a plurality of recesses. When the continuous fiber composite sheets are respectively placed into the cavities through using the clamping devices, each of the continuous fiber composite sheets is disposed right above the corresponding recess, and the male mold and the female mold are combined after each of the protrusions and the corresponding recess are aligned with each other so that each of the continuous fiber composite sheets is pressed into a cavity constructed by the combined protrusion and recess corresponding to each other.

In an embodiment of the invention, the press forming apparatus further includes a carrier. The clamping devices are disposed on the carrier, and the carrier is capable of moving relative to the heater and the mold. The continuous fiber composite sheets are respectively clamped onto the carrier by the clamping devices, and the clamping devices are configured to adjust the tension of the continuous fiber composite sheets respectively.

In an embodiment of the invention, the carrier has a plurality of through holes, and a portion of clamping device is disposed around each of the through holes for clamping one continuous fiber composite sheet right above the corresponding through hole. After the continuous fiber composite sheets are respectively placed into the cavities through using the carrier and the clamping devices on the carrier, the carrier is moved to be located between the male mold and the female mold, and the male mold and the female mold are combined together after each of the through holes is aligned with the corresponding protrusion and recess so that each of the protrusions passes through the corresponding through hole to press the corresponding continuous fiber composite sheet into the corresponding recess.

In an embodiment of the invention, one side of the male mold configured with the protrusions or one side of the female mold configured with the recesses has a receiving area for accommodating the carrier and the clamping devices on the carrier between the male mold and the female mold.

In summary, the press forming apparatus for continuous fiber composite sheets and the corresponding press forming method in the invention can mold a plurality of continuous fiber composite sheets simultaneously in a plurality of cavities of a single mold, so as to avoid the occurrence of pulled-yarn, crooked yarn or broken yarn, which facilitates to improve manufacturing efficiency and quality of products.

In order to make the aforementioned features and advantages of the disclosure more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic cross-sectional view of a press forming apparatus according to an embodiment of the invention.

FIG. 1B and FIG. 1C are schematic cross-sectional views of a mold before/after combination in FIG. 1A.

FIG. 1D is a schematic top view of a carrier in FIG. 1A.

FIG. 2A and FIG. 2B are schematic cross-sectional views of a mold before/after combination in another embodiment of the invention.

### DESCRIPTION OF EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

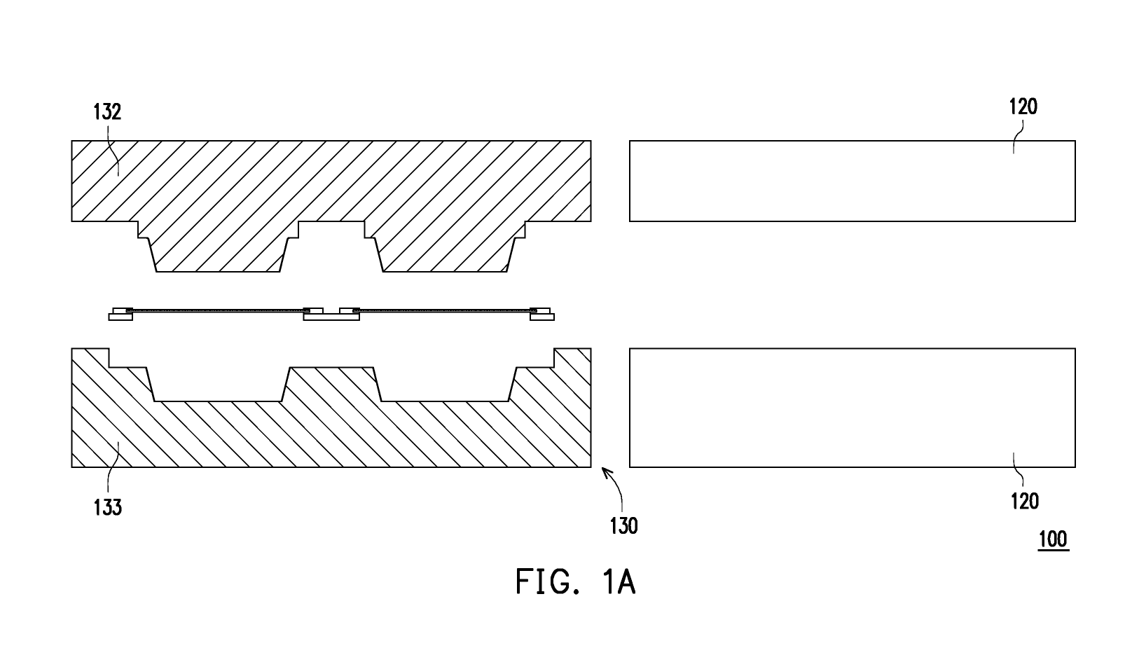

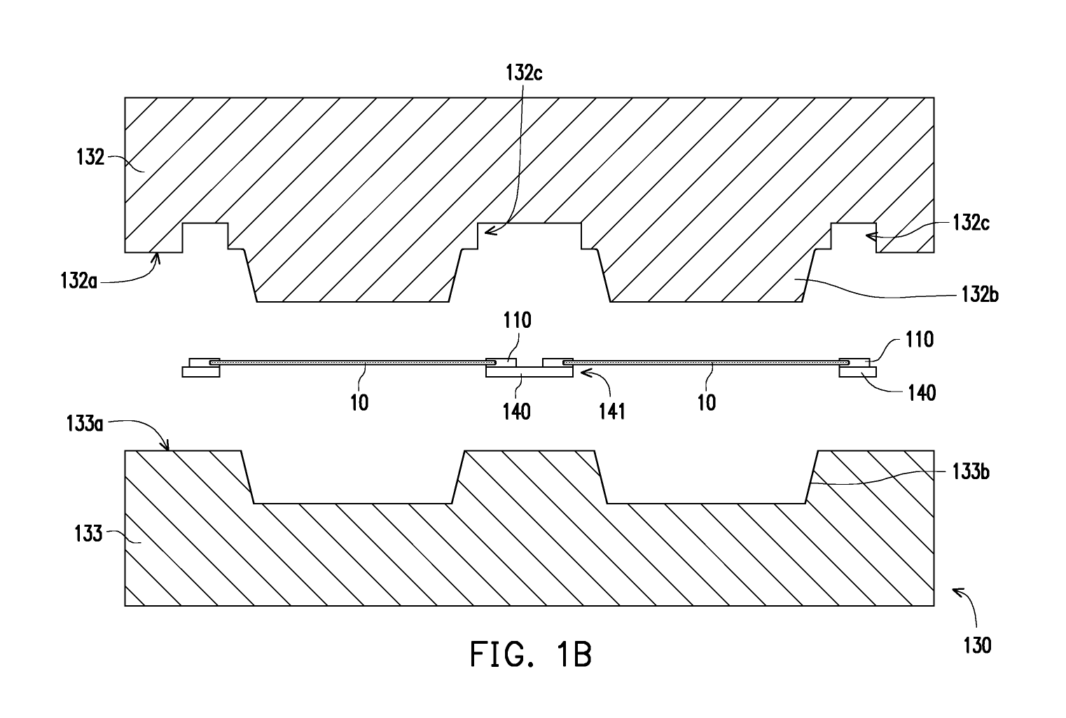

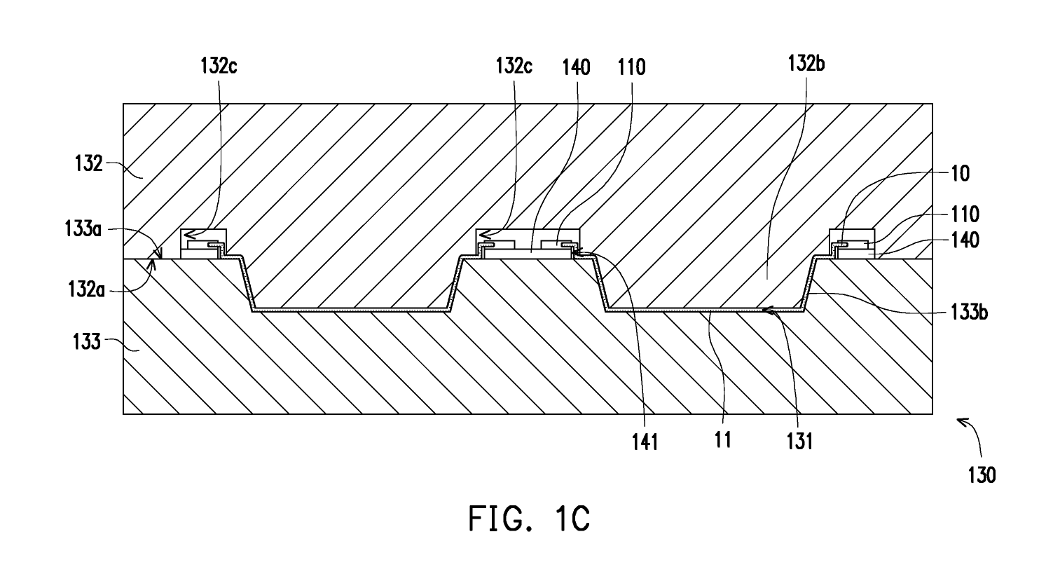

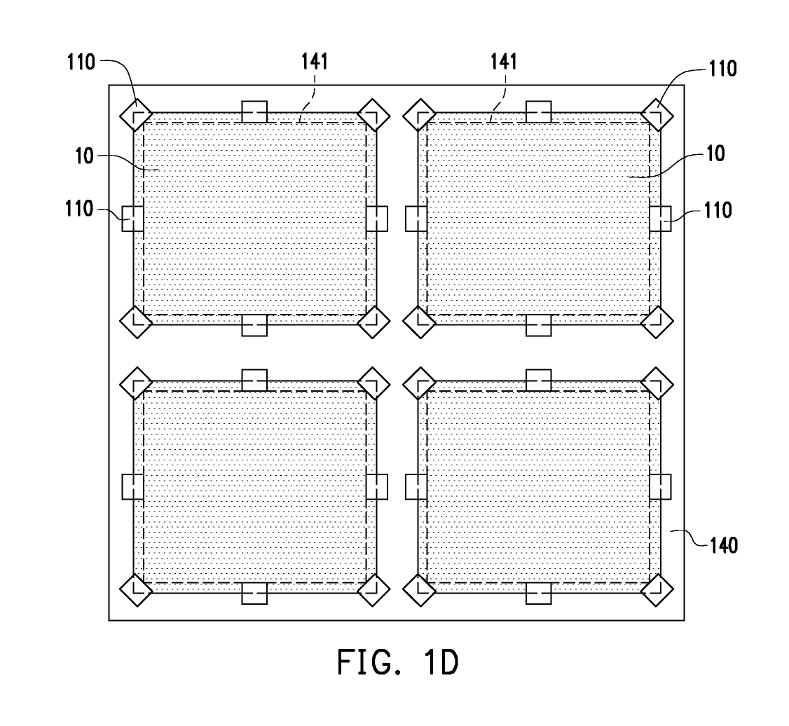

FIG. 1A is a schematic cross-sectional view of a press forming apparatus according to an embodiment of the invention. FIG. 1B and FIG. 1C are schematic cross-sectional views of a mold before/after combination in FIG. 1A. FIG. 1D is a schematic top view of a carrier in FIG. 1A. Referring to FIG. 1A to FIG. 1C, in the embodiment, a press forming apparatus 100 includes a plurality of clamping devices 110, a heater 120 and a mold 130, wherein the clamping devices 110 are respectively configured to clamp a plurality of continuous fiber composite sheets 10 and move the continuous fiber composite sheets 10 respectively to the position where the heater 120 or the mold 130 is located depending on the manufacturing step to conduct the heating and softening as well as molding steps respectively.

The heater 120 is disposed at one side of the mold 130 and configured to heat the continuous fiber composite sheets 10 prior to the molding step. The heater 120 may be an infrared heater; however, the invention provides no limitation to the types of heater. The mold 130 has a plurality of cavities 131. After the heater 120 heats the continuous fiber composite sheets 10 and make the continuous fiber composite sheets 10 become softened, the clamping devices 110 respectively move the heated and softened continuous fiber composite sheets 10 to the position where the mold 130 is located. Specifically, the mold 130 includes a male mold 132 and a female mold 133. In the process that the heated and softened continuous fiber composite sheets 10 are moved to the position where the mold 130 is located, the male mold 132 and the female mold 133 are separated from each other (i.e., the mold 130 is in a separated state) so that the heated and softened continuous fiber composite sheets 10 are moved to be located between the male mold 132 and the female mold 133 and respectively aligned with the cavities 131. Thereafter, the male mold 132 and the female mold 133 are combined (i.e., the mold 130 is switched to a combined state) so that the heated and softened continuous fiber composite sheets 10 are respectively placed into the cavities 131 to carry out the molding step.

After the heated and softened continuous fiber composite sheets 10 are molded into a plurality of articles 11, the male mold 132 and the female mold 133 are separated from each other (i.e., the mold 130 is switched to the separated state), and the articles 11 are respectively moved out of the cavities 131 using the clamping devices 110. Thereafter, the articles 11 are respectively removed from the clamping devices 110, and the articles 11 are cut or treated via other subsequent steps depending on the circumstances. In other words, by using the press forming apparatus 100 and the corresponding press forming method, the plurality of articles 11 can be acquired simultaneously from a single mold 130 in one time of molding, which facilitates to improve manufacturing efficiency. It should be pointed out that one time of molding refers to the process of combining, molding and separating the mold.

Referring to FIG. 1B to FIG. 1D, one of the continuous fiber composite sheets 10 is described for exemplary purpose. A number of clamping devices 110 are, for example, uniformly distributed around the continuous fiber composite sheet 10. By using the clamping devices 110 to clamp the continuous fiber composite sheet 10, the continuous fiber composite sheet 10 can be spread smoothly. More specifically, the clamping devices 110 may be configured in pairs. In other words, one of the pair of clamping devices 110 and the other one of the pair of clamping devices 110 are respectively disposed on two opposite sides of the continuous fiber composite sheet 10 to apply an appropriate degree of tension on the continuous fiber composite sheet 10 to prevent the continuous fiber composite sheet 10 from falling or generating corrugation in the moving, heating or molding process.

In the embodiment, the press forming apparatus 100 further includes a carrier 140 configured to carry the clamping devices 110, wherein the carrier late 140 has a plurality of through holes 141, and the through holes 141 are arranged in matrix. Take one of the through holes 141 as an example; a number of clamping devices 110 are, for example, distributed uniformly around the through hole 141, and the clamping devices 110 are configured to clamp one continuous fiber composite sheet 10 to be located above the through hole 141. Specifically, the clamping devices 110 may be configured in pairs. In other words, one of the pair of clamping devices 110 and the other one of the pair of the clamping devices 110 are respectively disposed on two opposite sides of the through hole 141 to apply an appropriate degree of tension on the continuous fiber composite sheet 10 to prevent the continuous fiber composite sheet 10 from falling or generating corrugation in the moving, heating or molding process. For example, the through hole 141 may be a quadrangle-shaped hole, which should not be construed as a limitation to the invention. In another embodiment, the through hole may be a circular hole, an oval-shaped hole or other polygon-shaped hole.

On the other hand, the male mold 132 has a first joint surface 132a and a plurality of protrusions 132b, wherein the protrusions 132b are protruded from the first joint surface 132a and arranged in matrix. The female mold 133 has a second joint surface 133a and a plurality of recesses 133b, wherein the second joint surface 133a cooperates with the first joint surface 132a, and the recesses 133b are concaved inward the second joint surface 133a and arranged in matrix. The number of the protrusions 132b is equal to the number of the recesses 133b, and the geometric contour of each of the protrusions 132b is complementary to the geometric contour of the corresponding recess 133b. In the condition that the mold 130 is in the separated state, the protrusions 132b are respectively aligned with the recesses 133b.

The number of the through holes 141 on the carrier 140, the number of the protrusions 132b and the number of the recesses 133b are equal to one another. After the continuous fiber composite sheets 10 are respectively clamped by the clamping devices 130 to be located right above the through holes 141, the carrier 140 is moved to be located between the male mold 132 and the female mold 133 separated from each other (i.e., the mold 130 is in the separated state). After it is ensured that the protrusions 132b are respectively aligned with the recesses 133b, the through holes 141 are respectively aligned with the protrusions 132b, and respectively aligned with the recesses 133b. In the meantime, the continuous fiber composite sheets 10 are also respectively aligned with the protrusions 132b and respectively aligned with the recesses 133b, wherein the continuous fiber composite sheets 10 are, for example, respectively located right beneath the protrusions 132b and respectively located right above the recesses 133b. In another embodiment, the upper and lower positions of the male mold and female mold may be switched. After the continuous fiber composite sheets are respectively aligned with the protrusions of the male mold and respectively aligned with the recesses of the female mold, the continuous fiber composite sheets are, for example, respectively located right above the protrusions of the male mold and respectively located right beneath the recesses of the female mold.

After it is ensured that the protrusions 132b, the recesses 133b and the through holes 141 are respectively aligned with each other, the male mold 132 and the female mold 133 are combined together (i.e., the mold 130 is switched to the combined state) so that each of the protrusions 132b passes through the corresponding through hole 141 to press the corresponding continuous fiber composite sheet 10 into the corresponding recess 133b, that is, to press each of the continuous fiber composite sheets 10 into the cavity 131 constructed by the combined protrusion 132b and the recess 133b corresponding to each other. During the combining process, since the carrier 140 and the clamping devices 110 disposed thereon are located between the first joint surface 132a of the male mold 132 and the second joint surface 133a of the female mold 133, in order to avoid that the carrier 140 and the clamping devices 110 disposed thereon hinder the combination of the male mold 132 and the female mold 133, or that the first joint surface 132a of the male mold 132 and the second joint surface 133a of the female mold 133 cause damage to the clamping devices 110, the male mold 132 further has a receiving area 132c, which is, for example, a receiving groove concaved inward the first joint surface 132a, and is configured to accommodate the carrier 140 and the clamping devices 110 disposed thereon during the combining process. On the other hand, it is required that the geometric contour of the receiving groove concaved inward the first joint surface 132a be complementary to the geometric contour of the carrier 110 in FIG. ID, and the size of the receiving groove concaved inward the first joint surface 132a needs to be slightly larger than the size of the carrier 110 so as to accommodate the carrier 140 and the clamping devices 110 disposed thereon in the combining process.

Referring to FIG. 1A to FIG. 1D, in the embodiment, the continuous fiber composite sheets 10 may be a combination of at least one of polypropylene (PP), polycarbonate (PC), acrylonitrile-butadiene-styrene copolymers (ABS), polymethylmethacrylate (PMMA), thermoplastic polyurethane (TPU), polyamide (PA) and polyphenylene sulphide (PPS) and at least one of carbon fiber, glass fiber, basalt fiber, Kevlar fiber, polyester and linen fiber, wherein polypropylene (PP), polycarbonate (PC), acrylonitrile-butadiene-styrene copolymers (ABS), polymethylmethacrylate (PMMA), thermoplastic polyurethane (TPU), polyamide (PA) and polyphenylene sulphide (PPS) may serve as a base, and the carbon fiber, glass fiber, basalt fiber, Kevlar fiber, polyester and linen fiber may serve as reinforcement material.

For example, after the continuous fiber composite sheet 10 is clamped by the two opposite clamping devices 110, by changing the distance between the two opposite clamping devices 110, for example, the distance between a clamping portion (not shown) of one of the two opposite clamping devices 110 for clamping the continuous fiber composite sheet 10 and a clamping portion (not shown) of the other one of the two opposite clamping devices 110 for clamping the continuous fiber composite sheet 10, the tension applied on the continuous fiber composite sheet 10 can be adjusted. If the distance between the clamping portion (not shown) of one of the two opposite clamping devices 110 for clamping the continuous fiber composite sheet 10 and the clamping portion (not shown) of the other one of the two opposite clamping devices 110 for clamping the continuous fiber composite sheet 10 is enlarged, the tension applied on the continuous fiber composite sheet 10 is also increased so that a partial region of the continuous fiber composite sheet 10 is tensioned. On the contrary, if the distance between the clamping portion (not shown) of one of the two opposite clamping devices 110 for clamping the continuous fiber composite sheet 10 and the clamping portion (not shown) of the other one of the two opposite clamping devices 110 for clamping the continuous fiber composite sheet 10 is reduced, the tension applied on the continuous fiber composite sheet 10 is also decreased so that the partial region of the continuous fiber composite sheet 10 is loosened.

After any one of the continuous fiber composite sheets 10 is clamped by the plurality of corresponding clamping devices 110, the timing for adjusting the tension applied on one of the continuous fiber composite sheets 10 is described below.

After the continuous fiber composite sheet 10 is clamped onto the carrier 140 by the plurality of corresponding clamping devices 110 and disposed right above the corresponding through hole 141, the tension applied on the continuous fiber composite sheet 10 or the degree of tightness in the partial region of the continuous fiber composite sheet 10 can be adjusted by the two opposite clamping devices 110 to allow the continuous fiber composite sheet 10 to be spread smoothly, thereby avoiding that the continuous fiber composite sheet 10 is brought into contact with the carrier 140 or the machine or component in the press forming apparatus 100. In other words, before the continuous fiber composite sheet 10 is heated, it is required to use any two opposite clamping devices 110 to adjust the tension applied on the continuous fiber composite sheet 10 to prevent the continuous fiber composite sheet 10 from falling or generating corrugation. In this manner, the quality of the article 11 obtained in the subsequent manufacturing process can be improved.

After the continuous fiber composite sheet 10 is heated and softened, the continuous fiber composite sheet 10 is likely to fall or generate corrugation due to effect of gravity. At this time, at least any two opposite clamping devices 110 may be used to adjust the tension applied on the continuous fiber composite sheet 10 or the degree of tightness in the partial region of the continuous fiber composite sheet 10, such that the continuous fiber composite sheet 10 can be tensioned without being brought into contact with the carrier 140 or the machine or component in the press forming apparatus 100. In other words, in the process that the continuous fiber composite sheet 10 is heated, the tension of the continuous fiber composite sheet 10 is adjusted, which facilitates to improve the quality of the article 11 obtained in the subsequent manufacturing process.

For example, the heater 120 may be configured with a sensor (not shown) configured to sense the degree of softness of the heated and softened continuous fiber composite sheet 10. The sensor (not shown) may be a temperature sensor (e.g., infrared temperature sensor) or a distance sensor (e.g., infrared distance sensor). Take the temperature sensor as an example. The temperature sensor may be used to sense the temperature in different areas of the heated and softened continuous fiber composite sheet 10, and transmit the obtained temperature data to a controller (not shown) signally coupled to the temperature sensor so that the controller (not shown) can calculate the degree of softness of the heated and softened continuous fiber composite sheet 10 according to the material of the continuous fiber composite sheet 10 and the received temperature data, and transmit a control signal to the clamping device 110 signally coupled to the controller (not shown), thereby adjusting the tension applied on the heated and softened continuous fiber composite sheet 10 or the degree of tightness in partial region of the heated and softened continuous fiber composite sheet 10. Take the distance sensor as an example. The distance sensor may be used to sense the degree of softness (or degree of sagging) in different areas of the heated and softened continuous fiber composite sheet 10, and transmit the obtained data regarding degree of softness to a controller (not shown) signally coupled to the distance sensor so that the controller (not shown) can transmit a control signal to the clamping device 110 signally coupled to the controller (not shown) according to the received data regarding degree of softness, thereby adjusting the tension applied on the heated and softened continuous fiber composite sheet 10 or the degree of tightness in partial region of the heated and softened continuous fiber composite sheet 10.

In the process that the heated and softened continuous fiber composite sheet 10 is pressed into the cavity 131, the continuous fiber composite sheet 10 may be deformed due to being subjected to force. At this time, by adjusting the tension applied on the continuous fiber composite sheet 10 or the degree of tightness in partial region of the continuous fiber composite sheet 10 through using at least two opposite clamping devices 110, the heated and softened continuous fiber composite sheet 10 can be tensioned. Thereafter, the mold 130 may be subjected to a molded forming process, a pressure forming process or a vacuum forming process to form the heated and softened continuous fiber composite sheet 10 into the article 11.

Specifically, in the process that the heated and softened continuous fiber composite sheet 10 is molded, it is required to combine the male mold 132 and the female mold 133 first so the protrusion 132b of the male mold 132 and the recess 133b of the female mold 133 are respectively brought into contact with the heated and softened continuous fiber composite sheet 10. Since the protrusion 132b of the male mold 132 are in contact with the area of different regions of the heated and softened continuous fiber composite sheet 10 at different timing and positions, it is required to use the clamping device 110 to adjust the tension applied on the heated and softened continuous fiber composite sheet 10 or the degree of tightness in the partial region of the heated and softened continuous fiber composite sheet 10, thereby avoiding that the heated and softened continuous fiber composite sheet 10 is cracked or generate corrugation.

Similarly, since the recess 133b of the female mold 133 are in contact with the area of different regions of the heated and softened continuous fiber composite sheet 10 at different timing and positions, it is required to use the clamping device 110 to adjust the tension applied on the heated and softened continuous fiber composite sheet 10 or the degree of tightness in the partial region of the heated and softened continuous fiber composite sheet 10, thereby avoiding that the heated and softened continuous fiber composite sheet 10 is cracked or generate corrugation.

In brief, the mold 130 in the embodiment is a multi-cavity mold that is designed to simultaneously mold a plurality of continuous fiber composite sheets 10 into a plurality of articles 11 in one time of molding process and improve the quality of the articles 11. The tension applied on each of the continuous fiber composite sheets 10 is adjusted respectively by using the plurality of corresponding clamping devices 110. In other words, in the same molding process, the tension applied on each of the continuous fiber composite sheets 10 is adjusted separately without intervening each other. As compared with this, if a single large-size continuous fiber composite sheet is molded in a multi-cavity mold, in the combining process, the large-size continuous fiber composite sheet would be pulled and dragged by each cavity, which would cause the thickness of partial region of the large-size continuous fiber composite sheet to be over thin or cause skewness or cracks.

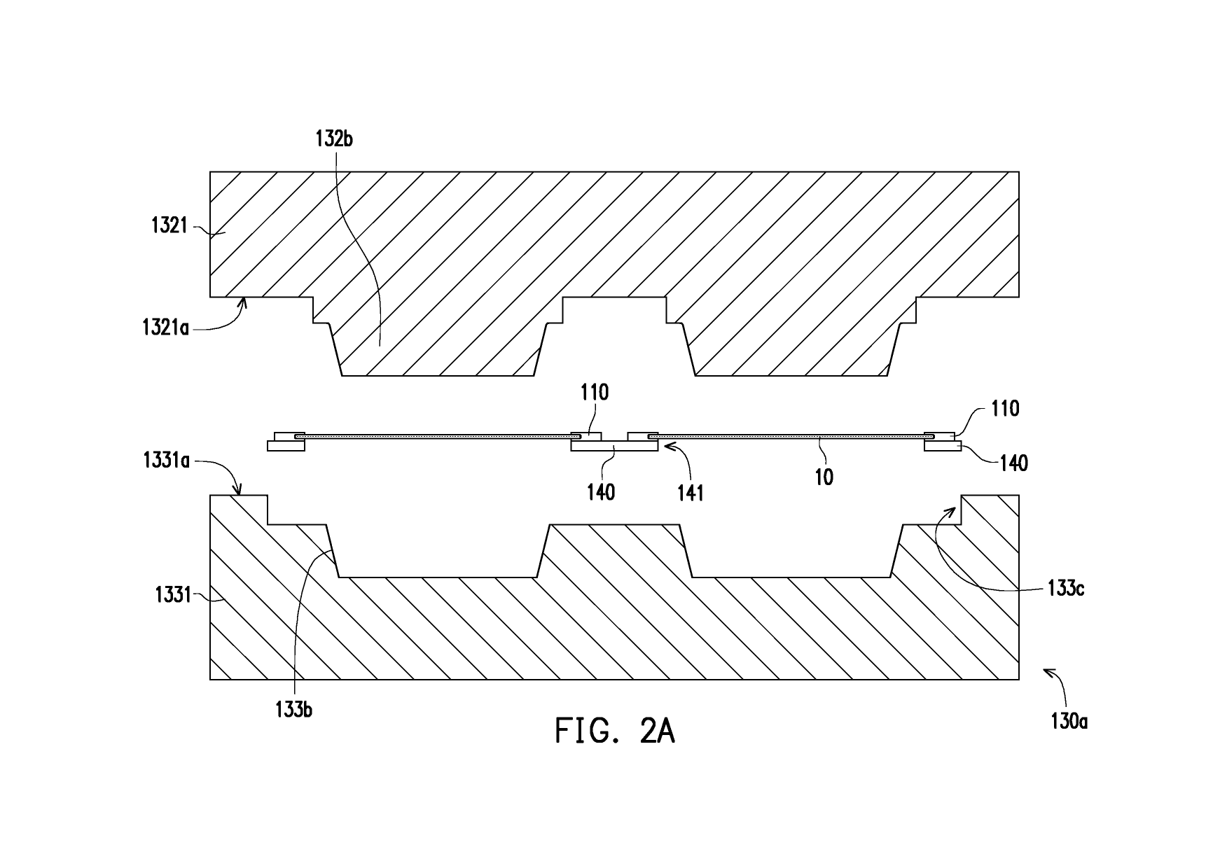

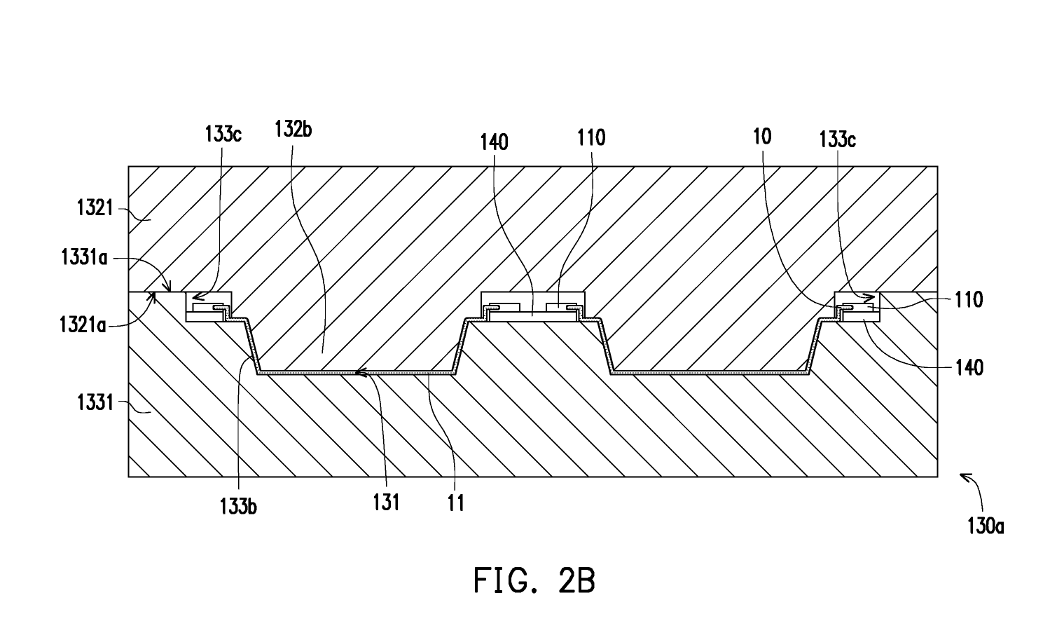

FIG. 2A and FIG. 2B are schematic cross-sectional views of a mold before/after combination in another embodiment of the invention. Referring to FIG. 2A and FIG. 2B, different from the mold 130 described in the previous embodiment, a receiving area 133c in a mold 130a of the embodiment is disposed at a female mold 1331. Furthermore, in order to avoid that the carrier 140 and the clamping devices 110 disposed thereon hinder the combination of a male mold 1321 and the female mold 1331, or that a first joint surface 1321a of the male mold 1321 and a second joint surface 1331a of the female mold 1331 cause damage to the clamping devices 110, the female mold 1331 further has the receiving area 133c, which is, for example, a receiving groove concaved inward the second joint surface 1331a configured to accommodate the carrier 140 and the clamping devices 110 disposed thereon in the combining process.

In summary, according to the invention, the press forming apparatus for the continuous fiber composite sheet and the corresponding press forming method thereof adopt a multi-cavity mold in order to simultaneously mold a plurality of continuous fiber composite sheets into a plurality of articles in one time of molding process and improve the quality of the articles. The tension applied on each of the continuous fiber composite sheets is adjusted respectively through using the plurality of corresponding clamping devices. In other words, in the same molding process, the tension applied on each of the continuous fiber composite sheets is adjusted separately without intervening each other, so that the occurrence of pulled-yarn, crooked yarn or broken yarn can be avoided. Accordingly, the press forming apparatus for continuous fiber composite sheet and the corresponding press forming method thereof not only facilitate to improve manufacturing efficiency but also helps to improve the quality of article.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. A press forming method for a continuous fiber composite sheet, comprising:
providing a plurality of continuous fiber composite sheets;
heating the continuous fiber composite sheets;
providing a mold having a plurality of cavities; and
placing the continuous fiber composite sheets respectively into the cavities, and the continuous fiber composite sheets are molded respectively.

2. The press forming method for the continuous fiber composite sheet according to claim 1, further comprising:
adjusting tension of the continuous fiber composite sheets respectively prior to heating the continuous fiber composite sheets.

3. The press forming method for the continuous fiber composite sheet according to claim 1, further comprising:
adjusting tension of the continuous fiber composite sheets respectively in the process that the continuous fiber composite sheets are heated.

4. The press forming method for the continuous fiber composite sheet according to claim 1, further comprising:
adjusting tension of the continuous fiber composite sheets respectively in the process that the continuous fiber composite sheets are molded respectively.

5. The press forming method for the continuous fiber composite sheet according to claim 1, wherein the continuous fiber composite sheets are respectively pressed and formed through a molded forming method, a pressure forming method or a vacuum forming method.

6. The press forming method for the continuous fiber composite sheet according to claim 1, wherein the mold comprises a male mold and a female mold, the male mold has a plurality of protrusions, and the female mold has a plurality of recesses, when the continuous fiber composite sheets are respectively placed into the cavities, each of the continues fiber composite sheets are disposed right above the corresponding recess, and the male mold and the female mold are combined after each of the protrusions and corresponding recess are aligned with each other, such that each of the continuous fiber composite sheets is pressed into one of the cavities constructed by the combined protrusion and recess corresponding to each other.

7. The press forming method for the continuous fiber composite sheet according to claim 6, wherein the continuous fiber composite sheets are clamped onto a carrier, the carrier has a plurality of through holes, and one of the continuous fiber composite sheets is clamped right above each of the through holes, when the continuous fiber composite sheets are respectively placed into the cavities, the carrier is moved to be located between the male mold and the female mold, and the male mold and the female mold are combined after the each of the through holes and the corresponding protrusion and the recess are aligned with each other, such that each of the protrusions passes through the corresponding through hole to press the corresponding continuous fiber composite sheet into the corresponding recess.

8. A press forming apparatus for a continuous fiber composite sheet, comprising:
a plurality of clamping devices, respectively configured to clamp a plurality of continuous fiber composite sheets;
a heater, configured to heat the continuous fiber composite sheets; and
a mold, disposed at a side of the heater, and having a plurality of cavities, after the heater heats the continuous fiber composite sheets, the continuous fiber composite sheets are moved to a position where the mold is located by using the clamping devices, and the continues fiber composite sheets are respectively placed into the cavities so that the continuous fiber composite sheets are molded respectively.

9. The press forming apparatus for the continuous fiber composite sheet according to claim 8, wherein the mold comprises a male mold and a female mold, the male mold has a plurality of protrusions and the female mold has a plurality of recesses, when the continuous fiber composite sheets are respectively placed into the cavities through using the clamping devices, each of the continuous fiber composite sheets is disposed right above the corresponding recess, and the male mold and the female mold are combined after each of the protrusions and the corresponding recess are aligned with each other, such that each of the continuous fiber composite sheets is pressed into one of the cavities constructed by the combined protrusion and recess corresponding to each other.

10. The press forming apparatus for the continuous fiber composite sheet according to claim 9, further comprising:
a carrier, the clamping devices are disposed on the carrier, and the carrier are capable of moving relative to the heater and the mold, the continuous fiber composite sheets are respectively clamped onto the carrier by using the clamping devices, and the clamping devices are configured to adjust tension of the continuous fiber composite sheets respectively.

11. The press forming apparatus for the continuous fiber composite sheet according to claim 10, wherein the carrier has a plurality of through holes, and a portion of the clamping devices is disposed around each of the through holes for clamping one of the continuous fiber composite sheets to be right above the corresponding through hole, when the continuous fiber composite sheets are respectively placed into the cavities by using the carrier and the clamping devices on the carrier, the carrier is moved to be located between the male mold and the female mold, and the male mold and the female mold are combined after each of the through holes and the corresponding protrusion and the recess are aligned with each other, such that each of the protrusions passes through the corresponding through hole to press the corresponding continuous fiber composite sheet into the corresponding recess.

12. The press forming apparatus for the continuous fiber composite sheet according to claim 11, wherein a side of the male mold configured with the protrusions or a side of the female mold configured with the recesses has a receiving area for accommodating the carrier and the clamping devices on the carrier between the male mold and the female mold.
